(19) United States
(12) Patent Application Publication
(10) Pub. No.: US 2021/0108373 A1
(43) Pub. Date: Apr. 15, 2021

(54) COATED PRINTING PAPER

(71) Applicant: MITSUBISHI PAPER MILLS LIMITED, Tokyo (JP)

(72) Inventors: Jun URASAKI, Tokyo (JP); Masanori NAGOSHI, Tokyo (JP); Hideki TAKADA, Tokyo (JP)

(73) Assignee: MITSUBISHI PAPER MILLS LIMITED, Tokyo (JP)

(21) Appl. No.: 16/603,723

(22) PCT Filed: Mar. 13, 2018
(86) PCT No.: PCT/JP2018/009707

§ 371 Date: Oct. 8, 2019

(30) Foreign Application Priority Data
May 2, 2017 (JP) 2017-091701

(51) Int. Cl. D21H 27/00; D21H 19/40; D21H 19/38; D21H 19/54; D21H 19/58; D21H 19/62; B41M 5/52

(52) U.S. Cl. CPC D21H 27/00; D21H 19/40; D21H 19/385; B41M 5/5245; D21H 19/58; D21H 19/62; B41M 5/5218; D21H 19/54

(57) ABSTRACT

The present invention provides a coated printing paper having a base paper, and a coating layer arranged on at least one surface of the base paper, wherein,
an outermost coating layer positioned on the outermost side with respect to the base paper contains at least kaolin, calcium carbonate, starches, a latex, a dispersant, a lubricant and a cationic resin,
in the outermost coating layer, a total amount of the starches and the latex is 5 parts by mass or more and 13 parts by mass or less, and an amount of the dispersant is 0.02 part by mass or more and 0.3 part by mass or less, an amount of the lubricant is 0.25 part by mass or more and 0.6 part by mass or less, and an amount of the cationic resin is 0.25 part by mass or more and 0.5 part by mass or less, with respect to 100 parts by mass of the pigment containing kaolin and calcium carbonate in the outermost coating layer, and
a mass content ratio of the kaolin to the calcium carbonate in the outermost coating layer is kaolin:calcium carbonate=1:9 to 6:4, and a mass content ratio of the starches to the latex in the outermost coating layer is starches:latex=1:9 to 4:6.

According to the present invention, a coated printing paper having printing stain resistance, resistance to color density unevenness and dullness resistance can be provided.

### TECHNICAL FIELD

The present invention relates to a coated printing paper capable of printing with an inkjet printing press while being a coated printing paper for an offset printing press.

### BACKGROUND ART

Inkjet recording system is a system in which ink droplets are ejected from fine nozzles onto a recording paper and deposited on the paper to form ink dots for recording.

The inkjet recording system is used for small printers for home and small office/home office (SOHO), wide format printers used for POP and poster production, and on-demand printing presses used for producing commercial printed materials. There are printing papers of various glossy ranging from matte tones to gross tones. The paper quality required is different from each other between printing paper for the production of commercial printed materials such as business documents, DM, books, brochures, flyers, pamphlets and catalogs, and photographic paper developed as alternatives of silver halide photos in the inkjet recording system in terms of cost of printed matter, printed productivity and handling of printed matter.

As on-demand inkjet printing paper that is inexpensive but has suitability for high-speed inkjet printing and that has suitability for offset printing and letterpress printing which are general commercial printing, on-demand coated printing paper is known that has an ink-receiving layer on at least one surface of a base paper and is obtained by calendaring processing, in which the base paper does not contain an internal sizing agent and an external sizing agent, and contains an internal paper strengthening agent, the ink receiving layer contains a pigment, a styrene butadiene latex, and a lubricant, and further contains starch, calcium carbonate accounts for 40% by mass or more of the pigment, and the on-demand coated printing paper is for high-speed inkjet printing using aqueous ink at 14.85 m/min or higher for sheet paper and 20 m/min or higher for roll paper (e.g., see Patent Document 1).

Plate printing presses such as an offset printing press and a letterpress printing press require a “plate” on which printing image has been formed. On the other hand, an on-demand printing press does not need a “plate”. That is, in the on-demand printing press, an image-forming apparatus prints directly on the printing paper according to digital information regarding image.

There is an on-demand printing press that uses inkjet recording system, i.e., an inkjet recording press. Examples of the inkjet recording press include Truepress Jet manufactured by SCREEN Graphic and Precision Solutions Co., Ltd., the MJP Series manufactured by Miyakoshi Printing Machinery Co., Ltd., Prosper and VERSAMARK manufactured by Eastman Kodak Company, JetPress manufactured by Fujifilm Corp., and Color Inkjet Web Press manufactured by Hewlett Packard.

These inkjet printing presses have color printing speeds that are ten to several tens of times faster than inkjet printers for home and small office/home office (SOHO) use as well as wide format inkjet printers, and the inkjet printing presses operate at printing speeds of 15 m/min or higher and exceeding 100 m/min in the case of high-speed printing, depending on various printing conditions. Because of this, inkjet printing presses are distinguished from inkjet printers for home and SOHO use and wide format inkjet printers.

### PRIOR ART DOCUMENTS

### Patent Documents

Patent Document 1: Japanese Patent Application Kokai Publication No. 2016-147398 (unexamined, published Japanese patent application)

### SUMMARY OF THE INVENTION

### Problems to be Solved by the Invention

Due to the spread of on-demand printing presses, it is necessary for coated printing paper to be compatible with not only plate printing presses but also on-demand printing presses. In particular, it is necessary for coated printing paper to be applicable to an offset printing press and an inkjet printing press which are often used for the production of commercial printed materials.

In an offset printing press, ink adhering to a plate contacts with a printing paper via a blanket and is transferred to the printing paper to produce printed materials. The inkjet printing press ejects ink droplets onto a printing paper from fine nozzles that are not in contact with the paper to produce printed materials. Due to such a difference in printing mechanism, the ink of the offset printing press has adhesiveness and high concentration of coloring materials. The ink of the inkjet printing press has fluidity and low concentration of coloring materials.

When conventional coated printing paper for an offset printing press is used in an inkjet printing press, absorption of ink cannot follow the printing speed as printing speed increases, so printing stain may be generated in some cases. In addition, color density unevenness may occur in a single color printed portion. In addition, the color of the printed portion may be dull and the saturation may be reduced. “Color density unevenness” is a phenomenon in which the ink absorption of the coated printing paper partially varies as the printing speed of the inkjet printing press increases, and as a result, color shading is partially visible in the printed portion that should originally be formed with a single color. “Saturation” relates to the vividness of the color. Generally, the physical elements that make up a color are “hue”, “saturation”, and “density”, and “saturation”, which is the vividness of the color, and “density”, which is the color intensity, are different elements.

These are considered to be caused by the difference in printing method and ink between the offset printing press and the inkjet printing press. Color density unevenness and reduction of saturation reduce the value of commercial prints.

According to “Paper Coating-Application of Polymer Latex” (written by Soichi Muroi, published by Koubunshi Kanko-kai, 1992), the coating layer-coating composition for forming the coating layer of the coated printing paper is basically composed of a pigment, a latex and a water-soluble polymer as a binder, and a dispersant, a lubricant, a defoamer, an antifoamer, a preservative, an insolubilizer, and the like are blended as additives.

In order to obtain the quality required for paper while adapting to the new printing method, these materials are examined for types and contents. However, the number of combinations is almost infinite.

An object of the present invention is to provide a coated printing paper having the following qualities for an inkjet printing press, aiming to be able to print with an inkjet printing press while being a coated printing paper having suitability for an offset printing press

(1) Suppression of printing stains (printing stain resistance)
(2) Suppression of color density unevenness in a single color printed portion (resistance to color density unevenness).
(3) Suppression of reduction of saturation of a printed portion (dullness resistance)

### Means for Solving the Problems

As a result of intensive study by the present inventors, the objects of the present invention can be achieved by the following items.

[1] A coated printing paper having a base paper, and a coating layer arranged on at least one surface of the base paper, wherein,

an outermost coating layer positioned on the outermost side with respect to the base paper contains at least kaolin, calcium carbonate, starches, a latex, a dispersant, a lubricant and a cationic resin,

in the outermost coating layer, a total amount of the starches and the latex is 5 parts by mass or more and 13 parts by mass or less, and an amount of the dispersant is 0.02 part by mass or more and 0.3 part by mass or less, an amount of the lubricant is 0.25 part by mass or more and 0.6 part by mass or less, and an amount of the cationic resin is 0.25 part by mass or more and 0.5 part by mass or less, with respect to 100 parts by mass of the pigment containing kaolin and calcium carbonate in the outermost coating layer, and

a mass content ratio of the kaolin to the calcium carbonate in the outermost coating layer is kaolin:calcium carbonate=1:9 to 6:4, and a mass content ratio of the starches to the latex in the outermost coating layer is starches:latex=1:9 to 4:6.

### Effects of the Invention

According to the present invention, a coated printing paper having printing stain resistance, resistance to color density unevenness and dullness resistance can be provided.

### MODE FOR CARRYING OUT THE INVENTION

The present invention will be described below in detail.

The coated printing paper of the present invention has a base paper, and a coating layer arranged on at least one surface of the base paper. An outermost coating layer positioned on the outermost side with respect to the base paper contains at least kaolin and calcium carbonate as a pigment, starches and a latex as a binder, a dispersant, a lubricant and a cationic resin.

In the present invention, “having a coating layer” means a paper having a distinct coating layer that can be distinguished from a base paper when observing a cross section of the paper with an electron microscope. For example, in the case where a resin component or a polymer component is coated, the amount of the coated components is small and absorbed by the base paper, and as a result, the printing paper does not have a distinct layer that can be distinguished from the base paper when observing a cross section of the printing paper with an electron microscope, it does not correspond to “having a coating layer”.

The base paper is a raw paper sheet produced from paper stock obtained by mixing at least one type of pulp selected from chemical pulp such as leaf bleached kraft pulp (LBKP) and needle bleached kraft pulp (NBKP), mechanical pulp such as groundwood pulp (GP), pressure groundwood pulp (PGW), refiner mechanical pulp (RMP), thermo mechanical pulp (TMP), chemi-thermo mechanical pulp (CTMP), chemi mechanical pulp (CMP), and chemi groundwood pulp (CGP), and waste paper pulp such as de-inked pulp (DIP), and one or more types of various fillers, such as precipitated calcium carbonate, ground calcium carbonate, talc, clay and kaolin, and one or more types of various additives such as a sizing agent, a fixing agent, a retention aid, a cationization agent such as a cationic resin and a polyvalent cationic ion salt, and a paper strengthening agent, as necessary. Further, the base paper may include woodfree paper obtained by subjecting calendering processing, surface sizing with starch, polyvinyl alcohol or the like, or surface treatment to the raw paper. Furthermore, the base paper may include woodfree paper subjected to surface sizing or surface treatment followed by calendering processing.

In the paper stock, one or two kinds of other additives, such as a pigment dispersant, a thickener, a fluidity improver, a defoamer, an antifoamer, a releasing agent, a foaming agent, a penetrating agent, a colored dye, a colored pigment, an optical brightener, an ultraviolet light absorber, an antioxidant, a preservative, a fungicide, an insolubilizer, an wetting paper strengthening agent and a drying paper strengthening agent may be incorporated as long as desired effects of the invention are not impaired.

The coating layer can be provided on at least one side of the base paper by applying and drying a coating composition of the coating layer. The coating layer includes one layer or two or more layers. In the coating layer, a coating layer positioned on the outermost side with respect to the base paper is referred to as an outermost coating layer. When the coating layer includes one layer, the coating layer means the outermost coating layer. When there are two or more coating layers, for the coating layer existing between the base paper and the outermost coating layer, the presence or absence and type of each of a pigment, a binder, and various additives are not particularly limited.

The each coating amount of the coating layer(s) is not particularly limited. A preferable coating amount is in the range of 5 g/m² or more and 30 g/m² or less per one side in dry solid content. When the coating layer is composed of two or more layers, the above value is the total value of them. When the coating layer is composed of two or more layers, it is preferable that the outermost coating layer accounts for 70% by mass of the coating amount per one side in dry solid content.

The coating layer may be provided on one side or both sides of the base paper. When the coating layer is provided on one side of the base paper, a conventional back coat layer may be provided on the surface of the base paper opposite to the side having the coating layer.

A method of providing the coating layer on the base paper is not particularly limited. For example, there can be mentioned a method of applying and drying a coating composition of a coating layer using a coating apparatus and a drying apparatus conventionally known in the papermaking field. Examples of the coating apparatus include a comma coater, a film press coater, an air knife coater, a rod blade coater, a bar coater, a blade coater, a gravure coater, a curtain coater, an E bar coater, a film transfer coater, and the like. Examples of the drying apparatus include various drying apparatuses such as a hot air dryer such as a straight tunnel dryer, an arch dryer, an air loop dryer and a sine curve air float dryer, an infrared heating dryer, a dryer using microwave, and the like.

The coating layer can be subjected to calendering process.

The calendering process is a process of averaging smoothness and thickness by passing paper between rolls. Examples of calendering apparatuses include a machine calender, a soft nip calender, a super calender, a multistage calender, a multi nip calender, and the like.

The printing paper of the present invention does not include the printing paper on which the outermost coating layer has been subjected to cast processing.

The outermost coating layer contains kaolin and calcium carbonate as a pigment.

The mass content ratio of the kaolin to the calcium carbonate in the outermost coating layer is kaolin:calcium carbonate=1:9 to 6:4. Calcium carbonate is preferably ground calcium carbonate from the viewpoint of printing suitability for an inkjet printing press.

In addition to the kaolin and the calcium carbonate, the outermost coating layer can contain a conventionally known pigment. Examples of the conventionally known pigment can include inorganic pigments such as talc, satin white, lithopone, titanium oxide, zinc oxide, silica, alumina, aluminum hydroxide, activated clay and diatomaceous earth, and organic pigments such as plastic pigments. The outermost coating layer can contain one or a combination of two or more of these pigments in combination with kaolin and calcium carbonate.

The proportion of kaolin and calcium carbonate in the pigment of the outermost coating layer is 80% by mass or more.

The outermost coating layer contains starches and a latex as a binder.

Starches are polysaccharides in which glucose is polymerized by glycosidic bonds, and polysaccharides in which a hydroxyl group(s) of glucose is modified by various substituents in polysaccharides in which the glucose is polymerized by glycosidic bonds. Examples of the starches include starch, an oxidized starch, an enzyme-modified starch, an etherified starch, a cationic starch, an amphoteric starch, a dialdehyde starch, a phosphate esterified starch and an urea phosphate esterified starch, a hydroxyethylated starch, a hydroxybutylated starch, and the like. The starches is preferably an urea phosphate esterified starch.

The urea phosphate esterified starch is a starch having a phosphoric acid ester group and a carbamic acid ester group in glucose. As an example of a method for introducing a phosphoric acid ester group, there can be mentioned a method in which a phosphate such as sodium tripolyphosphate is added alone to cause a baking reaction. As an example of a method for introducing a phosphoric acid ester group and a carbamic acid ester group, there can be mentioned a method in which urea is added together with inorganic phosphoric acids to cause a baking reaction. The urea phosphate esterified starch can be obtained in various degrees of urea substitution mainly by the latter method of baking the inorganic phosphoric acids and urea.

The urea phosphate esterified starch preferably has an average urea substitution degree of 0.005 or more and 0.05 or less. “Urea substitution degree” is the degree of substitution of the hydroxyl group of the glucose unit constituting the starch by the carbamic acid ester group. For example, urea substitution degree=0.02 means that there are two substituents per 100 glucose units constituting starch. The urea substitution degree is a conventionally known value for starch and is determined by a known method. For example, it can be determined from the nitrogen content using a pyrolysis GC method or a CHN element analyzer. “Starch Science Experiment Method”, edited by Shigeo Suzuki and Michinori Nakamura, 1st edition published in 1979, and published by Asakura Publishing Co., Ltd. can be also refereed to.

In the present invention, a latex refers to a polymer resin that can be stably dispersed in water. Examples of the latex include conventionally known water-dispersible binders, including conjugated diene resins such as a styrene-butadiene copolymer or an acrylonitrile-butadiene copolymer, acrylic resins such as an acrylic acid ester or methacrylic acid ester polymer or a methyl methacrylate-butadiene copolymer, vinyl resins such as an ethylene-vinyl acetate copolymer or a vinyl chloride-vinyl acetate copolymer, polyurethane resins, alkyd resins, unsaturated polyester resins, functional group-modified resins with functional group-containing monomers such as carboxyl groups of these various copolymers, thermosetting synthetic resins such as a melamine resin or an urea resin, a natural rubber, and the like.

The latex is preferably a styrene-butadiene copolymer resin.

The mass content ratio of the starches to the latex in the outermost coating layer is starches:latex=1:9 to 4:6 as a dry solid content.

The outermost coating layer can contain a conventionally known binder in addition to the starches and the latex. Examples of the binder can include cellulose derivatives such as carboxymethyl cellulose and hydroxyethyl cellulose, natural polymer resins such as casein, gelatin and soybean protein or derivatives thereof, polyvinyl pyrrolidone, polyvinyl alcohol and various modified polyvinyl alcohols thereof, polypropylene glycol, polyethylene glycol, and the like. The outermost coating layer contains one kind or two or more kinds selected from the group consisting of these binders in combination with the starches and the latex.

In the outermost coating layer, the starches and latex preferably account for 80% by mass or more in the binder of the outermost coating layer. In the outermost coating layer, the total content of the starches and the latex is 5 parts by mass or more and 13 parts by mass or less with respect to 100 parts by mass of the pigment containing kaolin and calcium carbonate in the outermost coating layer.

The outermost coating layer contains a dispersant. The dispersant is a material for dispersing an water-insoluble substance such as a pigment in an aqueous solution and is a conventionally known dispersant. Examples of the conventionally known dispersant include a polycarboxylic acid resin such as sodium polycarboxylate, an acrylic resin such as sodium polyacrylate, a styrene-acrylic resin, an isobutylene-maleic acid resin, a sulfonated polystyrene resin, polyvinyl alcohol and modified polyvinyl alcohol, condensed phosphate and the like. The outermost coating layer contains one kind or two or more kinds selected from these dispersants.

The dispersant in the outermost coating layer is preferably one or two or more selected from the group consisting of a polycarboxylic acid resin and an acrylic resin.

The content of the dispersant in the outermost coating layer is 0.02 parts by mass or more and 0.3 parts by mass or less per side with respect to 100 parts by mass of the pigment containing kaolin and calcium carbonate in the outermost coating layer. Among the dispersant, there is a material that overlaps the binder. However, the content of the material used as the dispersant in the outermost coating layer is clearly smaller than that of the binder, and the dispersant is smaller in molecular weight than the binder, so that the dispersant and the binder are distinguishable. Although the pigment can be dispersed by the presence of the binder, by containing the dispersant in the outermost coating layer, resistance to color density unevenness can be improved.

The outermost coating layer contains a lubricant. The lubricant is a conventionally known lubricant. Examples of the conventionally known lubricant can include a higher fatty acid salt, a wax and an organosilicon compound. Examples of the higher fatty acid salt include a metal salt (e.g., sodium, potassium, zinc and calcium salts thereof) of a higher fatty acid such as laurate, oleate, palmitate, stearate and myristate, and an ammonium salt of a higher fatty acid such as ammonium laurate, ammonium oleate, ammonium palmitate, ammonium stearate, and ammonium myristate. Examples of the wax include vegetable wax, animal wax, montan wax, paraffin wax, synthetic wax (hydrocarbon synthetic wax, polyethylene emulsion wax, higher fatty acid ester, fatty acid amide, ketone-amines, hydrogen hardened oil, etc.), aliphatic hydrocarbons such as polypropylene and polytetrafluoroethylene polymer and derivatives thereof. Examples of the organosilicon compound include polyalkylsiloxanes and derivatives thereof, dimethyl silicone oil, methylphenyl silicone oil, alkyl-modified silicone oil, alkyl-aralkyl modified silicone oil, amino-modified silicone oil, polyether-modified silicone oil, higher fatty acid-modified silicone oil, carboxyl-modified silicone oil, fluorine-modified silicone oil, epoxy-modified silicone oil, and the like. The outermost coating layer contains one or more selected from the group consisting of these lubricants.

The lubricant of the outermost coating layer is preferably a higher fatty acid salt.

The content of the lubricant in the outermost coating layer is 0.25 parts by mass or more and 0.6 parts by mass or less per side with respect to 100 parts by mass of the pigment containing kaolin and calcium carbonate in the outermost coating layer.

The outermost coating layer contains a cationic resin. The cationic resin is a conventionally known cationic resin. A preferred cationic resin is a polymer or an oligomer containing a primary to tertiary amine or a quaternary ammonium salt which is easily coordinated with a proton and dissociates when dissolved in water to give a cationic property. Further, a preferred cationic resin is a low cationic resin having a cationization degree of more than 0 meq/g and 3 meq/g or less or a highly cationic resin having a cationization degree of more than 3 meq/g. Here, the cationization degree is a value measured by a colloid titration method.

Examples of the conventionally known cationic resin include polyethyleneimine, polyamine and modified polyamine, polyvinylpyridine, polyamidoamine, polyvinylamine, modified polyamide, polyacrylamide, polyallylamine, polydialkylaminoethyl methacrylate, polydialkylaminoethyl acrylate, polydialkylaminoethyl methacrylamide, polydialkylaminoethylacrylamide, polyvinylbenzyltrimethylammonium chloride, polydiallyldimethylammonium chloride, a copolymer of allyldimethylammonium chloride and acrylamide and the like, a polycondensate of an aliphatic polyamine and an epihalohydrin compound such as a dimethylamine-epichlorohydrin polycondensate or a polycondensate of an aliphatic polyamine and an epihalohydrin compound such as diethylenetriamine-epichlorohydrin polycondensate, polyamine polyamide epichlorohydrin, dicyandiamide-formalin polycondensate, dicyandiamide diethylenetriamine polycondensate, polyepoxyamine, polyamide-epoxy resin, melamine resin, and urea resin. The outermost coating layer contains one or two or more selected from the group consisting of these cationic resins. The average molecular weight of the cationic resin is not particularly limited. The average molecular weight of the cationic resin is preferably 500 or more and 100,000 or less, and more preferably 1,000 or more and 60,000 or less.

The cationic resin of the outermost coating layer is preferably a modified polyamine or a modified polyamide.

The content of the cationic resin in the outermost coating layer is 0.25 parts by mass or more and 0.5 parts by mass or less per side with respect to 100 parts by mass of the pigment containing kaolin and calcium carbonate in the outermost coating layer.

The coated printing paper of the present invention can obtain printing stain resistance, resistance to color density unevenness and dullness resistance by containing kaolin and calcium carbonate as a pigment in the outermost coating layer, and by the total content of the starches and the latex and the mass content ratio of these, the content of the dispersant, the content of the lubricant, and the content of the cationic resin being in a specific range with respect to 100 parts by mass of the pigment containing kaolin and calcium carbonate in the outermost coating layer. When any one of the above does not fall within the above range, the coated printing paper cannot obtain at least one of printing stain resistance, resistance to color density unevenness and dullness resistance.

The outermost coating layer can further contain various additives conventionally known in the field of coated paper, if necessary. Examples of the additives can include a thickener, a fluidity improver, a defoamer, a foaming agent, a penetrating agent, a colored pigment, a colored dye, an optical brightener, an ultraviolet light absorber, an antioxidant, a preservative, a fungicide and the like.

### EXAMPLES

The present invention is described below more specifically using examples. It should be noted that the present invention is not limited to these examples. Here, “part by mass” and “% by mass” each represent “parts by mass” and “% by mass” of the dry solid content or the substantial component amount. The coating amount of the coating layer represents the dry solid content.

<Base Paper>

To pulp slurry composed of 100 parts by mass of LBKP having a freeness of 400 mL csf, 8 parts by mass of calcium carbonate as a filler, 1.0 part by mass of an amphoteric starch, 0.8 part by mass of aluminum sulfate, and an internal sizing agent were added to make a paper stock, which was formed into raw paper using the Fourdrinier papermaking machine. Starch was adhered to both sides of the obtained raw paper with a size press apparatus and the paper was subjected to machine calendering processing to prepare a base paper.

<Coating Composition of Outermost Coating Layer>

The coating composition of the outermost coating layer was prepared according to the following contents.

Kaolin: the number of parts is shown in Tables 1 and 2

Calcium carbonate: the number of parts is shown in Tables 1 and 2

Silica: the number of parts is shown in Tables 1 and 2

Starches: the type and the number of parts are shown in Tables 1 and 2

Latex: the type and the number of parts are shown in Tables 1 and 2

Dispersant: the type and the number of parts are shown in Tables 1 and 2

Lubricant: the type and the number of parts are shown in Tables 1 and 2

Cationic resin: the type and the number of parts are shown in Tables 1 and 2

The above contents were blended, mixed and dispersed with water, and the concentration was adjusted to 48% by mass.

(Coated Printing Paper)

Coated printing paper was prepared by the following procedure.

The coating composition of the outermost coating layer was applied on the both surfaces of the base paper using a blade coater, and then dried. After the drying, calendering processing was performed. The coating amount of the coating composition was 14 g/m² per one surface.

TABLE 1

| | | | | | | | | | Resis- | |
|---|---|---|---|---|---|---|---|---|---|---|
| | | | | | | | | | tance to | |
| Pigment | | | Binder | | | | Cationic | Prin- | color | |
| | Calcium | | Starches | Latex | Dispersant | Lubricant | resin | ting | den- | Dull- |
| Kaolin | carbonate | Silica | Type | Type | Type | Type | Type | stain | sity | ness |
| Part | Part | Part | Part | Part | Part | Part | Part | resis- | uneven- | resis- |

| | by mass | by mass | by mass | by mass | by mass | by mass | by mass | by mass | tance | ness | tance |
|---|---|---|---|---|---|---|---|---|---|---|---|
| Example | 10 | 90 | | Urea phosphate | Styrene- | Acrylic | Calcium | Modified | 5 | 4 | 5 |
| 1 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 30 | 70 | | Urea phosphate | Styrene- | Acrylic | Calcium | Modified | 5 | 5 | 5 |
| 2 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 3 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 4 | 5 |
| 4 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 32 | 48 | 20 | Urea phosphate | Styrene- | Acrylic | Calcium | Modified | 5 | 4 | 4 |
| 5 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 24 | 36 | 40 | Urea phosphate | Styrene- | Acrylic | Calcium | Modified | 5 | 3 | 3 |
| 6 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 7 | | | | esterified starch | butadiene | type | stearate | polyamide | | | |
| | | | | (Average urea | copolymer | resin | 0.6 | 0.5 | | | |
| | | | | substitution | 9 | 0.3 | | | | | |
| | | | | degree = 0.01) | | | | | | | |
| | | | | 1 | | | | | | | |
| Example | 40 | 60 | | Urea phosphate | Styrene- | Acrylic | Calcium | Modified | 5 | 5 | 5 |
| 8 | | | | esterified starch | butadiene | type | stearate | polyamide | | | |
| | | | | (Average urea | copolymer | resin | 0.6 | 0.5 | | | |
| | | | | substitution | 7 | 0.3 | | | | | |
| | | | | degree = 0.01) | | | | | | | |
| | | | | 3 | | | | | | | |
| Example | 40 | 60 | | Urea phosphate | Styrene- | Acrylic | Calcium | Modified | 5 | 5 | 5 |
| 9 | | | | esterified starch | butadiene | type | stearate | polyamide | | | |
| | | | | (Average urea | copolymer | resin | 0.6 | 0.5 | | | |
| | | | | substitution | 6 | 0.3 | | | | | |
| | | | | degree = 0.01) | | | | | | | |
| | | | | 4 | | | | | | | |
| Example | 40 | 60 | | Urea phosphate | Styrene- | Acrylic | Calcium | Modified | 4 | 5 | 5 |
| 10 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.005) | | | | | | | |
| | | | | 1.5 | | | | | | | |
| Example | 40 | 60 | | Urea phosphate | Styrene- | Acrylic | Calcium | Modified | 5 | 5 | 5 |
| 11 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.002) | | | | | | | |
| | | | | 1.5 | | | | | | | |
| Example | 40 | 60 | | Urea phosphate | Styrene- | Acrylic | Calcium | Modified | 5 | 5 | 5 |
| 12 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.05) | | | | | | | |
| | | | | 1.5 | | | | | | | |
| Example | 40 | 60 | | Urea phosphate | Styrene- | Acrylic | Calcium | Modified | 5 | 4 | 3 |
| 13 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.09) | | | | | | | |
| | | | | 1.5 | | | | | | | |
| Example | 40 | 60 | | Urea phosphate | Styrene- | Acrylic | Calcium | Modified | 5 | 4 | 3 |
| 14 | | | | esterified starch | butadiene | type | stearate | polyamide | | | |
| | | | | (Average urea | copolymer | resin | 0.6 | 0.5 | | | |
| | | | | substitution | 4.2 | 0.3 | | | | | |
| | | | | degree = 0.01) | | | | | | | |
| | | | | 0.8 | | | | | | | |
| Example | 40 | 60 | | Urea phosphate | Styrene- | Acrylic | Calcium | Modified | 3 | 4 | 5 |
| 15 | | | | esterified starch | butadiene | type | stearate | polyamide | | | |
| | | | | (Average urea | copolymer | resin | 0.6 | 0.5 | | | |
| | | | | substitution | 11.1 | 0.3 | | | | | |
| | | | | degree = 0.01) | | | | | | | |
| | | | | 1.9 | | | | | | | |
| Example | 40 | 60 | | Phosphate | Styrene- | Acrylic | Calcium | Modified | 4 | 4 | 3 |
| 16 | | | | esterified starch | butadiene | type | stearate | polyamide | | | |
| | | | | 1.5 | copolymer | resin | 0.6 | 0.5 | | | |
| | | | | | 8.5 | 0.3 | | | | | |
| Example | 40 | 60 | | Urea phosphate | Ethylene- | Acrylic | Calcium | Modified | 5 | 3 | 3 |
| 17 | | | | esterified starch | vinyl | type | stearate | polyamide | | | |
| | | | | (Average urea | acetate | resin | 0.6 | 0.5 | | | |
| | | | | substitution | copolymer | 0.3 | | | | | |
| | | | | degree = 0.01) | 8.5 | | | | | | |
| | | | | 1.5 | | | | | | | |
| Example | 40 | 60 | | Urea phosphate | Styrene- | Acrylic | Calcium | Modified | 5 | 5 | 5 |
| 18 | | | | esterified starch | butadiene | type | stearate | polyamide | | | |
| | | | | (Average urea | copolymer | resin | 0.6 | 0.5 | | | |
| | | | | substitution | 8.5 | 0.1 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 4 | 5 |
| 19 | | | | esterified starch | butadiene | type | stearate | polyamide | | | |
| | | | | (Average urea | copolymer | resin | 0.6 | 0.5 | | | |
| | | | | substitution | 8.5 | 0.02 | | | | | |
| | | | | degree = 0.01) | | | | | | | |
| | | | | 1.5 | | | | | | | |
| Example | 40 | 60 | | Urea phosphate | Styrene- | Polycarboxylic | Calcium | Modified | 4 | 4 | 4 |
| 20 | | | | esterified starch | butadiene | acid | stearate | polyamide | | | |
| | | | | (Average urea | copolymer | type | 0.6 | 0.5 | | | |
| | | | | substitution | 8.5 | resin | | | | | |
| | | | | degree = 0.01) | | 0.3 | | | | | |
| | | | | 1.5 | | | | | | | |
| Example | 40 | 60 | | Urea phosphate | Styrene- | Acrylic | Calcium | Modified | 5 | 5 | 5 |
| 21 | | | | esterified starch | butadiene | type | stearate | polyamide | | | |
| | | | | (Average urea | copolymer | resin | 0.45 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 22 | | | | esterified starch | butadiene | type | stearate | polyamide | | | |
| | | | | (Average urea | copolymer | resin | 0.25 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Ammonium | Modified | 4 | 4 | 5 |
| 23 | | | | esterified starch | butadiene | type | oleate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 24 | | | | esterified starch | butadiene | type | stearate | polyamide | | | |
| | | | | (Average urea | copolymer | resin | 0.6 | 0.4 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 25 | | | | esterified starch | butadiene | type | stearate | polyamide | | | |
| | | | | (Average urea | copolymer | resin | 0.6 | 0.25 | | | |
| | | | | substitution | 8.5 | 0.3 | | | | | |
| | | | | degree = 0.01) | | | | | | | |
| | | | | 1.5 | | | | | | | |
| Example | 40 | 60 | | Urea phosphate | Styrene- | Acrylic | Calcium | Modified | 5 | 5 | 5 |
| 26 | | | | esterified starch | butadiene | type | stearate | polyamide | | | |
| | | | | (Average urea | copolymer | resin | 0.6 | 0.5 | | | |
| | | | | substitution | 8.5 | 0.3 | | | | | |
| | | | | degree = 0.01) | | | | | | | |
| | | | | 1.5 | | | | | | | |

TABLE 2

| | | | | | | | | | | Resis- | |
|---|---|---|---|---|---|---|---|---|---|---|---|
| | | | | | | | | | | tance to | |
| | Pigment | | | Binder | | | | Cationic | Prin- | color | |
| | | Calcium | | Starches | Latex | Dispersant | Lubricant | resin | ting | den- | Dull- |
| | Kaolin | carbonate | Silica | Type | Type | Type | Type | Type | stain | sity | ness |
| | Part | Part | Part | Part | Part | Part | Part | Part | resis- | uneven- | resis- |
| | by mass | by mass | by mass | by mass | by mass | by mass | by mass | by mass | tance | ness | tance |
| Comparative | 40 | 60 | | — | Styrene- | Acrylic | Calcium | Modified | 1 | 3 | 3 |
| Example | | | | 0 | butadiene | type | stearate | polyamide | | | |
| 1 | | | | | copolymer 10 | resin 0.3 | 0.6 | 0.5 | | | |
| Comparative | 40 | 60 | | Phosphate | Styrene- | Acrylic | Calcium | Modified | 2 | 4 | 4 |
| Example | | | | esterified starch | butadiene | type | stearate | polyamide | | | |
| 2 | | | | 5 | copolymer 5 | resin 0.3 | 0.6 | 0.5 | | | |
| Comparative | 40 | 60 | | Phosphate | Styrene- | Acrylic | Calcium | Modified | 5 | 2 | 2 |
| Example | | | | esterified starch | butadiene | type | stearate | polyamide | | | |
| 3 | | | | 0.5 | copolymer 2.5 | resin 0.3 | 0.6 | 0.5 | | | |
| Comparative | 40 | 60 | | Phosphate | Styrene- | Acrylic | Calcium | Modified | 2 | 3 | 4 |
| Example | | | | esterified starch | butadiene | type | stearate | polyamide | | | |
| 4 | | | | 2.4 | copolymer 13.6 | resin 0.3 | 0.6 | 0.5 | | | |
| Comparative | 40 | 60 | | Phosphate | Styrene- | Acrylic | Calcium | Modified | 4 | 2 | 4 |
| Example | | | | esterified starch | butadiene | type | stearate | polyamide | | | |
| 5 | | | | 1.5 | copolymer 8.5 | resin 0 | 0.6 | 0.5 | | | |
| Comparative | 40 | 60 | | Phosphate | Styrene- | Acrylic | Calcium | Modified | 4 | 4 | 2 |
| Example | | | | esterified starch | butadiene | type | stearate | polyamide | | | |
| 6 | | | | 1.5 | copolymer 8.5 | resin 0.6 | 0.6 | 0.5 | | | |
| Comparative | 40 | 60 | | Phosphate | Styrene- | Acrylic | Calcium | Modified | 4 | 3 | 2 |
| Example | | | | esterified starch | butadiene | type | stearate | polyamide | | | |
| 7 | | | | 1.5 | copolymer 8.5 | resin 0.3 | 0 | 0.5 | | | |
| Comparative | 40 | 60 | | Phosphate | Styrene- | Acrylic | Calcium | Modified | 4 | 2 | 3 |
| Example | | | | esterified starch | butadiene | type | stearate | polyamide | | | |
| 8 | | | | 1.5 | copolymer 8.5 | resin 0.3 | 1 | 0.5 | | | |
| Comparative | 40 | 60 | | Phosphate | Styrene- | Acrylic | Calcium | Modified | 3 | 2 | 3 |
| Example | | | | esterified starch | butadiene | type | stearate | polyamide | | | |
| 9 | | | | 1.5 | copolymer 8.5 | resin 0.3 | 0.6 | 0 | | | |
| Comparative | 40 | 60 | | Phosphate | Styrene- | Acrylic | Calcium | Modified | 4 | 4 | 2 |
| Example | | | | esterified starch | butadiene | type | stearate | polyamide | | | |
| 10 | | | | 1.5 | copolymer 8.5 | resin 0.3 | 0.6 | 1 | | | |
| Comparative | 40 | 60 | 60 | Phosphate | Styrene- | Acrylic | Calcium | Modified | 5 | 2 | 3 |
| Example | | | | esterified starch | butadiene | type | stearate | polyamide | | | |
| 11 | | | | 1.5 | copolymer 8.5 | resin 0.3 | 0.6 | 0.5 | | | |
| Comparative | 40 | 60 | 40 | Phosphate | Styrene- | Acrylic | Calcium | Modified | 3 | 2 | 3 |
| Example | | | | esterified starch | butadiene | type | stearate | polyamide | | | |
| 12 | | | | 1.5 | copolymer 8.5 | resin 0.3 | 0.6 | 0.5 | | | |
| Comparative | 40 | 60 | 100 | Phosphate | Styrene- | Acrylic | Calcium | Modified | — | — | — |
| Example | | | | esterified starch | butadiene | type | stearate | polyamide | | | |
| 13 | | | | 1.5 | copolymer 8.5 | resin 0.3 | 0.6 | 0.5 | | | |

<Printing Stain Resistance>

Using an inkjet printing press MR 20 MX-7000 manufactured by Miyakoshi Printing Machinery Co., a 6000 m evaluation image was printed with an aqueous pigment ink under the condition of a printing speed of 150 m/min. The image to be evaluated was 3 cm×3 cm square solid patterns recorded in a single continuous row with seven colors, namely, black, cyan, magenta, yellow, and superimposed colors (red, green, blue) created by a combination of two colors out of the above three color inks except black. Printing stains present in the printed portion were visually observed, and the printing stain resistance was evaluated according to the following criteria depending on the degree of visibility. In the present invention, if the evaluation is 3 to 5, it is assumed that the printing paper has printing stain resistance.

5: No printing stain is recognized. Good.

4: Printing stain is almost not recognized. Almost good.

3: Printing stain is recognized slightly. However, there is no practical problem.

2: Printing stain is recognized a little.

1: Printing stain is recognized.

<Evaluation of Resistance to Color Density Unevenness>

Using an inkjet printing press MJP 20 MX-7000 manufactured by Miyakoshi Printing Machinery Co., a 6000 m evaluation image was printed with an aqueous pigment ink under the condition of a printing speed of 150 m/min. The image to be evaluated was 3 cm×3 cm square solid patterns recorded in a single continuous row with seven colors, namely, black, cyan, magenta, yellow, and superimposed colors (red, green, blue) created by a combination of two colors out of the above three color inks except black. The resistance to color density unevenness was evaluated based on the following criteria by visually observing the printed portion of each color solid portion image. In the present invention, if the evaluation is 3 to 5, it is assumed that the printing paper has resistance to color density unevenness.

5: The color density is uniform.

4: The color density is slightly non-uniform depending on the color.

3: The color density is slightly non-uniform.

2: The color density is partially non-uniform.

1: The color density is non-uniform throughout the printed portion.

<Dullness Resistance>

Using an inkjet printing press MJP 20 MX-7000 manufactured by Miyakoshi Printing Machinery Co., a 6000 m evaluation image was printed with an aqueous pigment ink under the condition of a printing speed of 150 m/min. The image to be evaluated was 3 cm×3 cm square solid patterns recorded in a single continuous row with seven colors, namely, black, cyan, magenta, yellow, and superimposed colors (red, green, blue) created by a combination of two colors out of the above three color inks except black. The dullness resistance was evaluated according to the following criteria by visually observing a decrease in the saturation of each color in comparison with a standard color sample. In the present invention, if the evaluation is 3 to 5, it is assumed that the printing paper has dullness resistance.

5: Good

4: Generally good.

3: Decrease in saturation is observed slightly. However, there is no practical problem.

2: Decrease in saturation is observed a little.

1: A decrease in saturation is observed.

The evaluation results are shown in Tables 1 and 2.

From Tables 1 and 2, it can be seen that Examples 1-26 corresponding to the present invention have printing stain resistance, resistance to color density unevenness and dullness resistance. On the other hand, it can be seen that Comparative Examples 1-12 which do not satisfy the constitution of the present invention cannot have these effects. In Comparative Example 13, blanket piling occurred for offset printing, and Comparative Example 13 was not a coated printing paper having suitability for an offset printing press.

1. A coated printing paper having a base paper, and a coating layer arranged on at least one surface of the base paper, wherein,
an outermost coating layer positioned on the outermost side with respect to the base paper contains at least kaolin, calcium carbonate, starches, a latex, a dispersant, a lubricant and a cationic resin,
in the outermost coating layer, a total amount of the starches and the latex is 5 parts by mass or more and 13 parts by mass or less, and an amount of the dispersant is 0.02 part by mass or more and 0.3 part by mass or less, an amount of the lubricant is 0.25 part by mass or more and 0.6 part by mass or less, and an amount of the cationic resin is 0.25 part by mass or more and 0.5 part by mass or less, with respect to 100 parts by mass of the pigment containing kaolin and calcium carbonate in the outermost coating layer, and
a mass content ratio of the kaolin to the calcium carbonate in the outermost coating layer is kaolin: calcium carbonate=1:9 to 6:4, and a mass content ratio of the starches to the latex in the outermost coating layer is starches:latex=1:9 to 4:6.
